(19) United States
(12) Patent Application Publication
(10) Pub. No.: US 2025/0193027 A1
(43) Pub. Date: Jun. 12, 2025

(54) SYSTEM AND METHOD FOR DISPLAYING AND ANALYZING INTERFACE VARIANTS FOR CONCURRENT ANALYSIS BY A USER

(71) Applicant: Indeed, Inc., Austin, TX (US)

(72) Inventors: Jason Wilkens, Sunnyvale, CA (US); Ryan Valentin, San Francisco, CA (US)

(21) Appl. No.: 19/060,240

(22) Filed: Feb. 21, 2025

Related U.S. Application Data
(63) Continuation of application No. 17/331,169, filed on May 26, 2021, now abandoned.
(60) Provisional application No. 63/030,287, filed on May 26, 2020.

(51) Int. Cl. H04L 9/32; G06F 3/04812; G06F 3/0482; G06F 3/0485; G06F 11/32; G06F 11/34; G06F 16/9035; G06F 16/957; G06F 18/21; G06F 18/214; G06F 18/40; G06F 40/131; G06N 3/09; G06N 20/00; G06Q 10/1053; G06Q 10/109; G06Q 30/0242; G06V 30/14; G06V 30/18; G06V 30/414; G06V 30/416; H04L 9/40; H04L 65/403

(52) U.S. Cl. CPC H04L 9/3268; G06F 3/04812; G06F 3/0482; G06F 3/0485; G06F 11/32; G06F 11/3409; G06F 11/3438; G06F 16/9035; G06F 16/957; G06F 18/2155; G06F 18/2163; G06F 18/2178; G06F 18/40; G06F 40/131; G06N 3/09; G06N 20/00; G06Q 10/1053; G06Q 10/109; G06V 30/1456; G06V 30/18086; G06V 30/414; G06V 30/416; H04L 9/3247; H04L 63/0428; H04L 63/166; H04L 65/403; G06F 11/3452; G06F 2203/04803; G06Q 30/0243; G06T 2210/12

(57) ABSTRACT

Systems and methods are disclosed for presenting images of multiple, variant user interfaces along with corresponding metrics for concurrent comparison by a user. Client interfaces allow a client to interact with an underlying system and/or application. Examples of client interfaces include webpages that are presented to a client in a client/server system. Embodiments of the disclosed system and method allow user interface designers to directly compare images of variants of a user interface and corresponding metrics with images of one or more other variants on a display. In at least one embodiment, an image of a variant and corresponding metrics are designated as a control against which images of other variants and corresponding metrics are directly compared on the display.

### CROSS-REFERENCE TO RELATED APPLICATION(S)

This application is a continuation of U.S. application Ser. No. 17/331,169, filed May 26, 2021, which claims the benefit of U.S. Provisional Application Ser. No. 63/030,287, filed May 26, 2020, the entire disclosures of which are herein incorporated by reference.

### FIELD OF THE DISCLOSURE

The present disclosure relates to electronic systems. More specifically, embodiments of the disclosure relate to a system and method for improving and applying technology related to displaying and analyzing user interface variants for concurrent analysis by a user.

### DESCRIPTION OF THE RELATED ART

Electronic systems utilize user interfaces (UIs) for a variety of purposes including displaying, observing, and collecting data. User interface designers and developers (collectively “developers”) often modify user interfaces to reflect updates in rendered data, changes in data collection, refreshing a look and feel of the interface to maintain engagement with a user, add new functionality, and so on. However, changes in any UI can have multiple intended and sometimes unintended consequences. However, such consequences can be difficult to detect, especially when considering multiple modified UI design choices.

### SUMMARY

A system of one or more computers can be configured to perform particular operations or actions by virtue of having software, firmware, hardware, or a combination of them installed on the system that in operation causes or cause the system to provide concurrently display images of variant user interfaces and corresponding metrics for concurrent comparison. At least one embodiment includes a computer-implemented method including: generating an experiment including multiple variants of a user interface, the experiment further including metrics that are to be monitored for the multiple variants, where the metrics are configured to provide data relating to interactions between a variant user interface and a client; deploying the multiple variants of the user interface; monitoring the metrics for the multiple variants of the user interface; retrieving the metrics associated with the multiple variants; and presenting images of the variants and corresponding real-time metrics for concurrent comparison on a display in response to user commands. Other embodiments of this aspect include corresponding computer systems, apparatus, and computer programs recorded on one or more computer storage devices, each configured to perform the actions of the methods.

At least one embodiment includes a system including a processor; a data bus coupled to the processor; and a non-transitory, computer-readable storage medium embodying computer program code, the non-transitory, computer-readable storage medium being coupled to the data bus, the computer program code including instructions executable by the processor for: generating an experiment including multiple variants of a user interface, the experiment further including metrics that are to be monitored for the multiple variants, where the metrics are configured to provide data relating to interactions between a variant user interface and a client; deploying the multiple variants of the user interface; monitoring the metrics for the multiple variants of the user interface; retrieving the metrics associated with the multiple variants; and presenting images of the variants and corresponding real-time metrics for concurrent comparison on a display in response to user commands.

At least one embodiment includes a non-transitory, computer-readable storage medium embodying computer program code, the computer program code may include computer executable instructions configured for: generating an experiment including multiple variants of a user interface, the experiment further including metrics that are to be monitored for the multiple variants, where the metrics are configured to provide data relating to interactions between a variant user interface and a client; deploying the multiple variants of the user interface; monitoring the metrics for the multiple variants of the user interface; retrieving the metrics associated with the multiple variants; and presenting images of the variants and corresponding real-time metrics for concurrent comparison on a display in response to user commands. Other embodiments of this aspect include corresponding computer systems, apparatus, and computer programs recorded on one or more computer storage devices, each configured to perform the actions of the methods

### BRIEF DESCRIPTION OF THE DRAWINGS

The present disclosure may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that is configured to implement certain embodiments of the system and method of the present disclosure.

FIG. 2 depicts an electronic environment in which certain embodiments of the disclosed system may operate.

FIG. 3 is a flowchart showing exemplary operations that may be executed by certain embodiments of the disclosed system.

FIG. 4 is a flowchart depicting exemplary operations that may be executed by certain embodiments of the disclosed system.

FIG. 5 is a flowchart depicting exemplary operations that may be executed by certain embodiments of the disclosed system.

FIG. 6 is a flowchart depicting exemplary operations that may be executed by certain embodiments to view the results of an experiment.

FIG. 7 is a screen shot of an exemplary embodiment of an interface that may be used in selecting and/or retrieving images of variants for an experiment.

FIG. 8 is a screen shot of an exemplary embodiment of an interface that may be used in selecting and/or retrieving an image of a variant that is to be used in the experiment.

FIG. 9 depicts a screen shot of an exemplary embodiment of an interface showing another manner of selecting images of variants for an experiment.

FIG. 10 depicts a screen shot of an exemplary interface that may be employed to allow a user to find and select an experiment for viewing.

FIG. 11 depicts a screen shot of an exemplary interface in which images for multiple variants are presented for concurrent comparison on a display.

FIG. 12 depicts a screen shot of an exemplary interface in which images of multiple variants are presented for concurrent comparison on a display.

### DETAILED DESCRIPTION

Systems and methods are disclosed for presenting images of multiple, variant user interfaces along with corresponding metrics for concurrent comparison by a user. Client interfaces allow a client to interact with an underlying system and/or application. Examples of client interfaces include webpages that are presented to a client in a client/server system. Certain styles of client interfaces may be more effective at driving user engagement with client-side applications when compared to other client interface designs, even when the client interfaces are designed for similar purposes. The effectiveness of a client interface depends on such things as types and placement of interface images on the interface, types and placement of interface controls, types and placement of menus, types and placement of instructional information on the interface, etc. Embodiments of the disclosed system and method allow user interface designers to directly compare images of variants of a user interface and corresponding metrics with images of one or more other variants on a display. In at least one embodiment, an image of a variant and corresponding metrics are designated as a control against which images of other variants and corresponding metrics are directly compared on the display.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of non-volatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

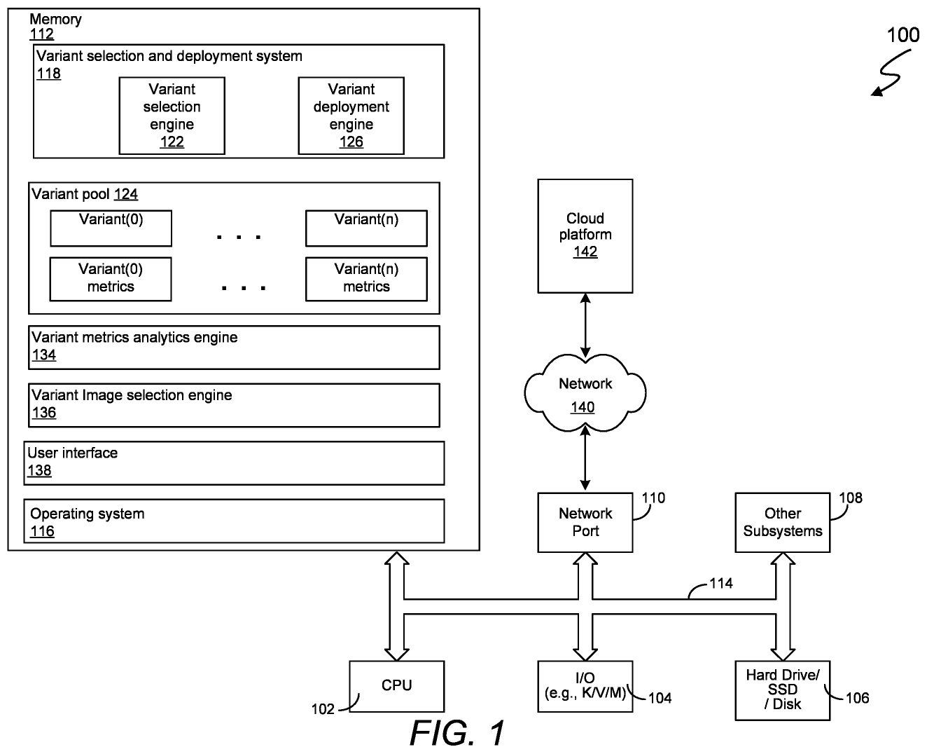

FIG. 1 is an information handling system 100 that is specially configured to implement embodiments of system and method for displaying and analyzing interface variants for concurrent analysis by a user. The information handling system 100 includes a processor (e.g., central processor unit or “CPU”) 102, input/output (I/O) devices 104, such as a display, a keyboard, a mouse, and associated controllers, a hard drive, SSD, or other disk storage 106. In certain embodiments, the processor 102 also interacts with other subsystems 108. In various embodiments, the information handling system 100 also includes network port 110 operable to connect to a cloud platform 142 through network 140. In certain embodiments, a user interacts with the various components and engines of the information handling system 100 through a user interface engine 138. In certain embodiments, the user interface engine 138 may include a web browser.

The information handling system 100 likewise includes system memory 112, which is interconnected to the foregoing via one or more buses 114. System memory 112 may be local memory, remote memory, memory distributed between multiple information handling systems, etc. System memory 112 further comprises an operating system 116 and in various embodiments may comprise other software modules and engines configured to implement certain embodiments of the disclosed system.

In the example shown in FIG. 1, memory 112 includes a variant selection and deployment system 118. In at least one embodiment, system 118 includes a variant selection engine 122 configured to allow a user to select which user interface variants are deployed in, for example, an experiment to assess the variants. In at least one embodiment, the metrics for the variants provide an indication of the effectiveness of client engagement with the variants in the experiment. In at least one embodiment, variant interfaces are user interfaces having different page styles and/or content that are intended to engage a user for substantially similar purposes. In the example shown in FIG. 1, the variant selection engine 122 is used to select which variants of a variant pool 124 are to be included in the experiment. In at least one embodiment, the variant pool 124 includes multiple variants, shown here as Variant(0) through Variant(n), where n is an integer index corresponding to the number of variants in the variant pool 124.

In certain embodiments, variant selection engine 122 is also employed to select which metrics to gather for variants in the variant pool 124. In certain embodiments, each variant is assigned an associated variant metric. In at least one embodiment, Variant metrics (0) through Variant metrics (n) are respectively associated with Variant(0) through Variant(n). In at least one embodiment, a single set of metrics are assigned to all variants used in the experiment so that a comparative analysis of the effectiveness of the variants use the same metrics. In at least one embodiment, when a single set of metrics are assigned to all variants, the variant pool 124 need not include multiple sets of variant metrics. Rather, in at least one embodiment, the variant metrics used across all variants can be assigned in a single selection operation using, for example, the variant selection engine 122 and stored with the experiment parameters as opposed to being stored with each variant.

In at least one embodiment, system 118 may include a variant deployment engine 126 configured to deploy the variants for the experiment to the cloud platform 142. In at least one embodiment, the variant deployment engine 126 is used define a deployment schedule for the variants of the experiment. The variant deployment engine 126 may also be configured to execute the actual deployment of the variants to the cloud platform 142. In certain embodiments, different variants are deployed for concurrent use on multiple cloud servers of the cloud platform 142. As an example, different variants may be deployed to different cloud servers so that the variant provided to a client is dependent on the servers on which the variant resides. In certain embodiments, the same variants are deployed in a time series manner so that a single variant is used concurrently at all cloud servers. As an example, a single variant may be deployed to all of the servers so that a single variant is provided to all clients accessing the cloud platform 142 independent of the servers on which the variant resides. As an extension of this example, all servers of the cloud platform 142 may initially operate with a first variant under a first set of operating conditions (e.g., set period of time) and operate with a second variant under a second set of operating conditions.

At least one embodiment includes a variant metrics analytics engine 134. In certain embodiments, the analytics engine 134 is configured to gather metrics data for the variants of the experiment from the servers of the cloud platform 142. In certain embodiments, the analytics engine 134 aggregates and formats the metrics data associated with the variants of the experiment for display at a display of the system 100.

Certain embodiments also include a variant image selection engine 136. In at least one embodiment, the variant image selection engine 136 allows a user to select images of the variants used in the experiment. In certain embodiments, the images of a variants and corresponding metrics are concurrently displayed to a user thereby allowing the user to compare the variants and corresponding metrics with one another on the same display.

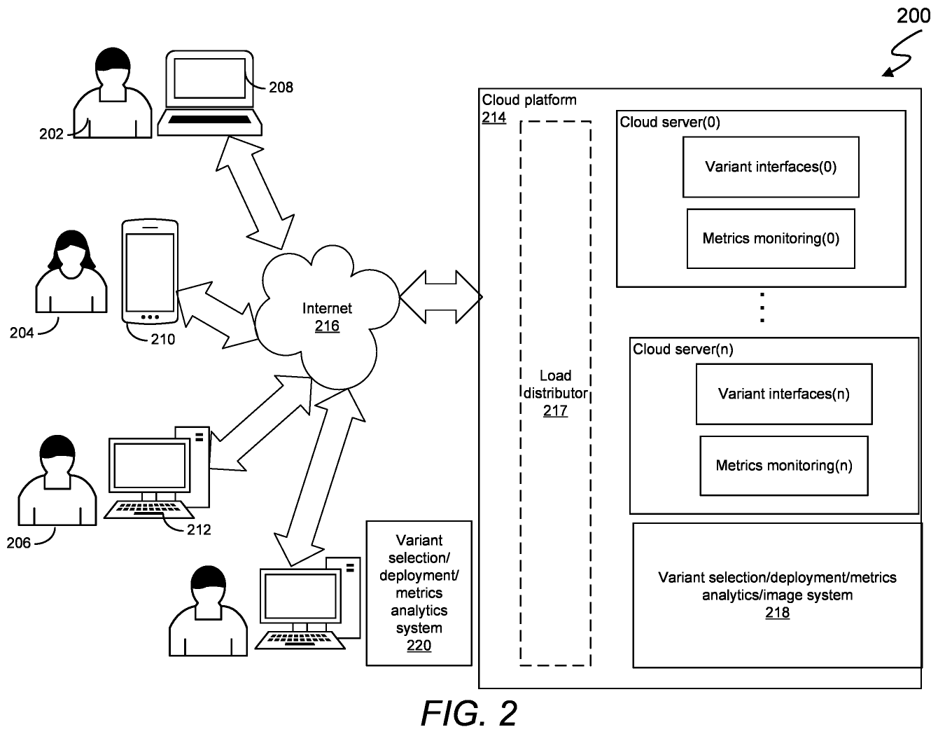

FIG. 2 depicts an exemplary electronic environment 200 in which certain embodiments of the disclosed system may operate. The exemplary environment 200 illustrates a plurality of users 202, 204, and 206 and respective client devices 208, 210, and 212 accessing services provided by cloud servers, Cloud server(0) through Cloud server(n) of a cloud platform 214 over a network, such as the Internet 216. In at least one embodiment, the cloud servers, Cloud server(0) through Cloud server(n), employ corresponding variant interface(s) for the experiment, Variant interfaces(0) through Variant interfaces(s). In at least one embodiment, the cloud servers execute metrics monitoring operations, shown here as Metrics monitor (0) through Metrics monitor(n) for variants employed at respective cloud servers, Cloud server (0) through Cloud Server (n). Although FIG. 2 shows different variant interfaces operating on different cloud servers, it will be recognized that the particular deployment of the variant interfaces may vary in response to provisioning of the cloud platform 214.

In certain embodiments, different variants are concurrently used at different cloud servers. In at least one embodiment, a loaded distributor 217 is used to evenly distribute traffic between the cloud servers so that cloud servers utilizing different variants of the same client interface receive the substantially the same traffic flow. Distributing the traffic flow equally between the cloud servers assists in ensuring that the metrics gathered by different cloud servers for the same variant may be properly compared. As an example, the load distributor 217 may direct an equal amount of traffic between multiple cloud servers employing the same variant interfaces so that the metrics gathered at one server are based on the same amount of traffic directed to other servers.

The exemplary environment 200 shown in FIG. 2 also shows a system 218 configured for variant selection, variant deployment, metrics analytics, variant image selection, and variant image and metrics comparison. In at least one embodiment, system 218 is implemented at a cloud server of the cloud platform 214. Additionally, or in the alternative, the environment 200 may include a variant selection/deployment/metrics analytics system 220 that operates as a client of the cloud platform 214. Based on the teachings of the present disclosure, it will be recognized that the operations executed by system 218 and/or system 220 may be distributed in a manner that is different from the manner shown in FIG. 2, the environment 200 being a non-limiting example.

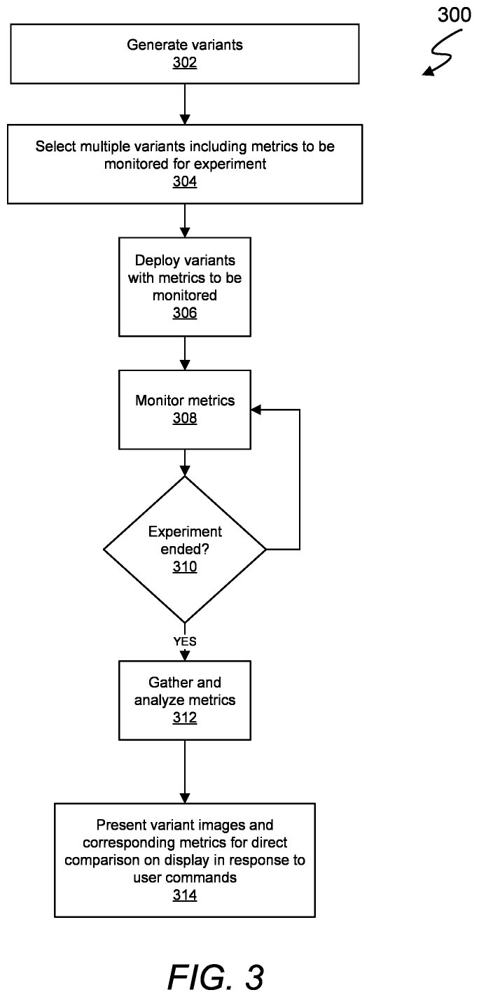

FIG. 3 is a flowchart 300 showing exemplary operations that may be executed by system disclosed in FIG. 2. In this example, system 218 generates variants at operation 302. In at least one embodiment, the variants are webpages that are intended to interact with a user in substantially similar manners, as disclosed herein. In at least one embodiment, the variants include similar content that is presented in different formats. As an example, a variant may have a control that is not present in another variant. As another example, a variant may have images that are not present in another variant. As another example, a variant may have text entry controls that are not present in another variant. As another example, a variant may have a menu type that is not present in another variant. Based on the teachings of the present disclosure, it is recognized that a substantial number of variants may be generated at operation 302 that are intended to allow user interactions having the same general purpose but with different user interfaces.

In at least one embodiment, parameters for the experiment are defined at operation 304. In certain embodiments, a user utilizing variant selection engine 122 defines the experiment by selecting multiple variants that are to be included in the experiment as well as the metrics that are to be monitored for the variants. At operation 306, system 118 deploys the variants and metrics of the experiment to, for example, one or more servers of Cloud servers(0)-(n). As the variants are accessed by clients, such as, the corresponding metrics are monitored at operation 308.

In certain embodiments, with system 118, a determination is made at operation 310 as to whether the experiment is to be ended. In at least one embodiment, the experiment is ended after all of the variants have been deployed and used for a predetermined period of time. In at least one embodiment, the experiment is ended after a predetermined amount of traffic has been received at a server hosting the variants. Other criterion may be used at operation 310 to terminate the experiment. If the criterion for ending the experiment is not met at operation 310, the metrics continue to be monitored at operation 308.

Once the experiment has ended at operation 310, variant metrics analytics engine 134 gathers and analyzes the metrics for the variants at operation 312. A variety of metrics may be gathered and analyzed. As an example, the metrics may include the percentage of times users opted to activate a control on the variant to proceed to another webpage, such as a survey page. As another example, the metrics may include sales of items or services presented on the variant. Other metrics may also be used to provide a comparative assessment between variants.

At operation 314, at least one embodiment of system 218 presents the images of the variants and corresponding metrics for direct comparison on a display in response to user commands. As an example, images of multiple variants as viewed by the client and the corresponding metrics for the multiple variants are presented on the display for direct comparison by a user. As an example, images of multiple variants and corresponding metrics may be concurrently presented on the display in a side-by-side manner. As another example, an image of a control may be fixed on the display as a user sequences through images of other variants so that images of one or more of the other variants are displayed concurrently with the control.

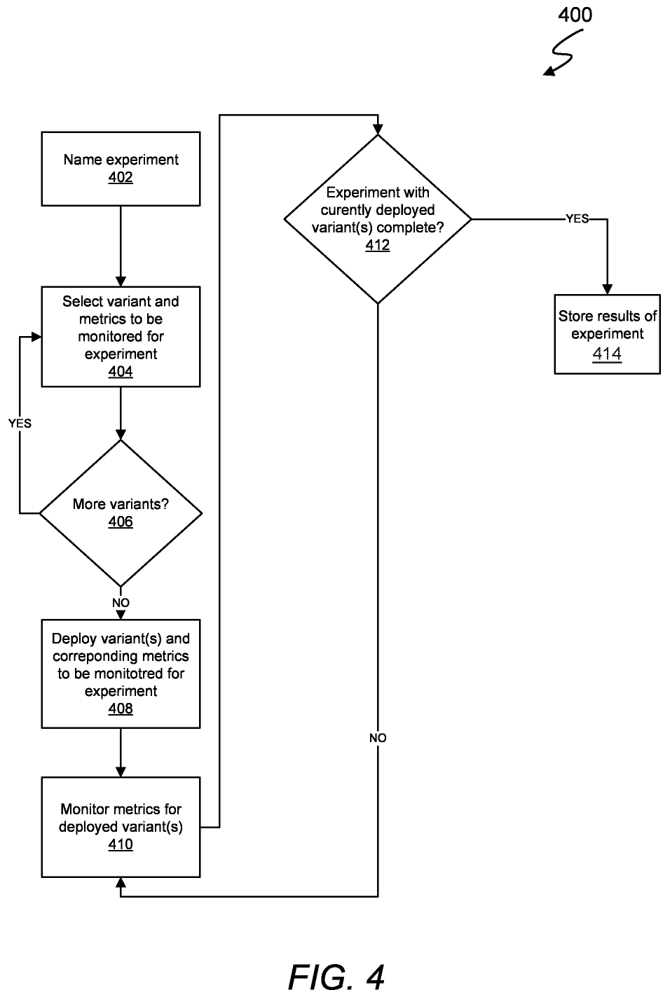

FIG. 4 is a flowchart 400 depicting exemplary operations that may be executed by certain components of the disclosed system. In at least one embodiment, the user names the experiment at operation 402 and sets the parameters for the experiment at operation 404. In this example, system 118 is used to select a variant to be deployed at operation 404 along with the metrics are to be monitored for the variants in the experiment. At operation 406, system 118 makes a determination of whether there are more variants that are to be employed in the experiment. If more variants are to be employed, the additional variant is selected by the user at operation 404. In some embodiments, if a different set of metrics are to be monitored for the additional variant, the metrics for the additional variant are also defined at operation 404. In certain embodiments, operation 404 and operation 406 are executed until all variants have been included for the defined experiment.

System 118 deploys the variants for the experiment to one or more cloud servers at operation 408. In at least one embodiment, all of the variants are deployed concurrently and the metrics for the deployed variants are also monitored concurrently at operation 410. In at least one embodiment, the metrics are monitored at operation 410 until a determination is made at operation 412 that the experiment with the currently deployed variants is complete. If the experiment is completed, the results of the experiment may be stored at operation 414. As an example, the results of the monitoring of the metrics for each of the deployed variants may be stored in electronic memory for retrieval and analysis.

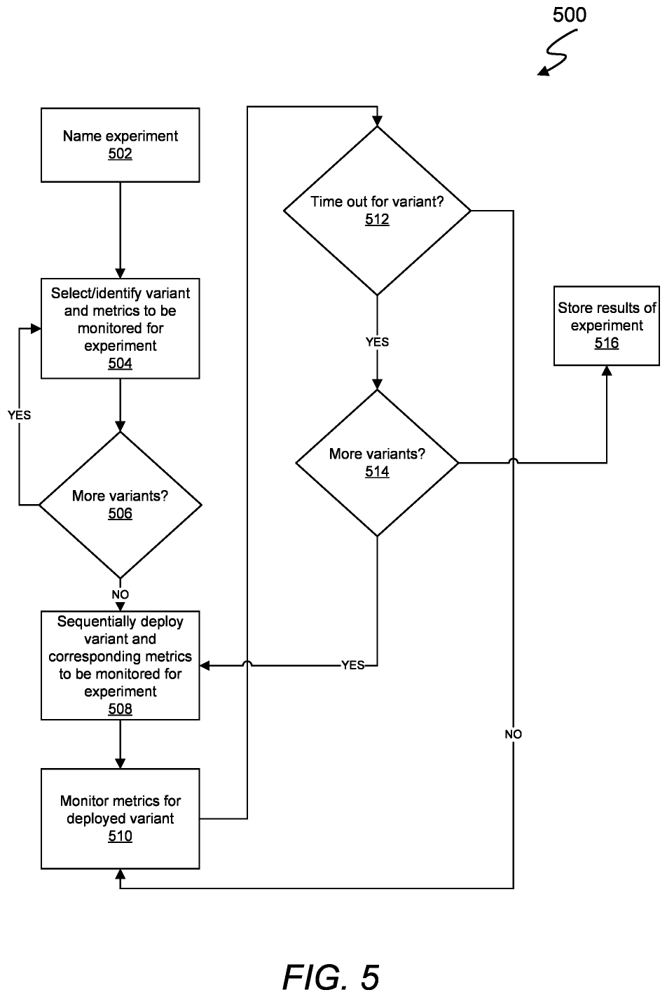

FIG. 5 is a flowchart 500 depicting another set of operations that may be executed by certain components of the disclosed system. The exemplary operations shown in FIG. 5 may be, for example, employed when variants are deployed in a time-sequenced manner to one or more cloud servers. As an example, a variant may be deployed for a predefined duration of time and, once the predetermined duration of time has elapsed, the next variant in a sequence may be deployed.

In at least one embodiment, the user names the experiment at operation 502 and sets the parameters for the experiment at operation 504. In this example, a variant that is to be deployed is selected at operation 504 along with the metrics are to be monitored for the variants in the experiment. In at least one embodiment, the metrics may include the predefined duration of time that the variant is to be utilized at one or more cloud servers. At operation 506, variant selection engine 122 determines whether there are more variants that are to be employed in the experiment. If more variants are to be employed, the additional variant is selected by the user at operation 504. In some embodiments, if a different set of metrics are to be monitored for the additional variant, the metrics for the additional variant are also defined at operation 504. In certain embodiments, operation 504 and operation 506 are executed until all variants have been included for the defined experiment.

In at least one embodiment, at operation 508 variant deployment engine 126 deploys one or more variants along with the metrics that are to be monitored for the deployed variant(s). The metrics for a variant are monitored at operation 510 until a timeout, based on the predetermined time, is reached at operation 512. If the predetermined time for the monitoring of the metrics of the deployed variant has not elapsed, at operation 510, the variant metrics analytics engine continues to monitor the metrics for the variant. If the predetermined time for monitoring the metrics of the deployed variant has been reached, system 118 at operation 514 determines whether there are more variants that are to be deployed as part of the experiment. If more variants are to be deployed, the next variant in the sequence is deployed at operation 508 by variant deployment engine 126 and the metrics for the deployed variant are monitored by variant metrics analytics engine 134 at operation 510 until the time for monitoring the variant has elapsed. Once all of the variants for the experiment have been deployed and monitored, the results for the experiment, such as the results of monitoring the metrics for each variant are stored at operation 516.

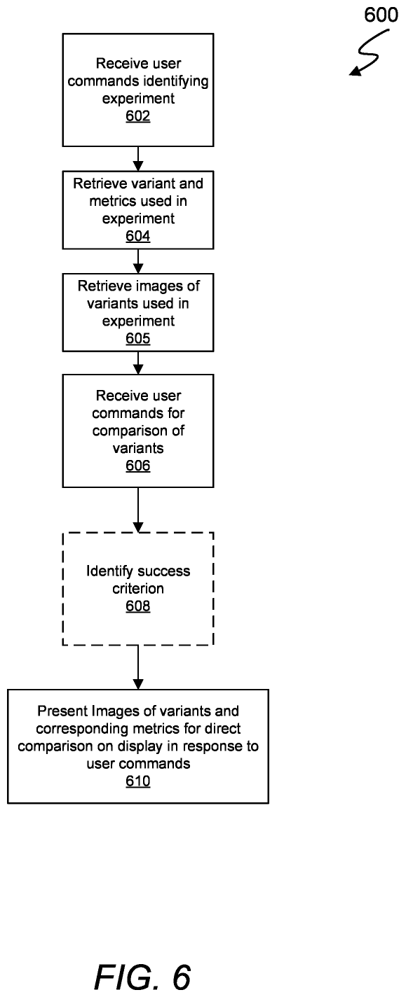

FIG. 6 is a flowchart 600 depicting exemplary operations that may be executed to view the results of an experiment. In certain embodiments, in operation 602, the user through the variant selection engine 122 provides commands to identify the experiment that is to be viewed. As an example, a user may be presented with one or more controls on a webpage identifying completed experiments. Additionally, or in the alternative, the variant selection engine 122 automatically generates a list of completed experiments to the user from which the user selects experiments. Other manners of allowing the user to select the experiment that is to be viewed may also be employed.

In certain embodiments, the variants and metrics used in the experiment are retrieved at operation 604. Images of the variants used in the experiment are selected and/or retrieved at operation 605. At operation 606, the user may provide commands to the variant selection engine 122 to retrieve the images of the variants and metrics that are to be concurrently displayed for comparison. In certain embodiments, the user may identify success criterion at operation 608 whereby an image corresponding to a variant meeting a predetermined threshold of effectiveness is flagged at the display for the user. At operation 610, variant selection and deployment system via user interface 138 presents the images of the variants and corresponding metrics for the variants to the user for direct comparison on a display in response to the user commands that were executed at operation 606.

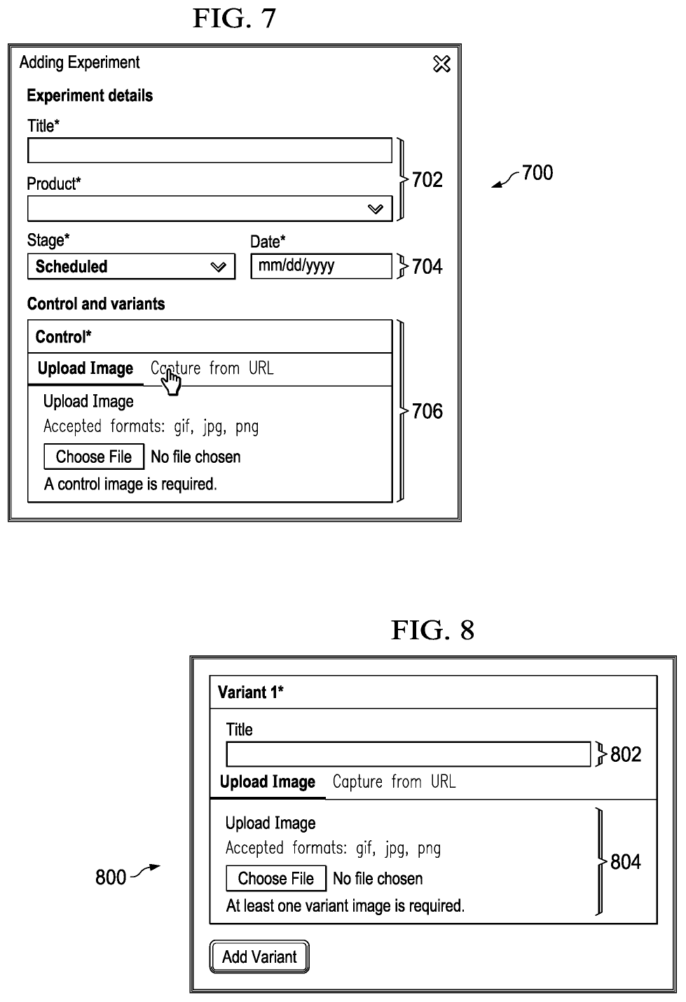

FIG. 7 is a screen shot 700 of an exemplary interface that may be used in selecting and/or retrieving images of variants for an experiment. In this example, the title for the experiment and product with which the experiment is associated may be entered at screen region 702. The stage of the experiment and a date associated with the stage of the experiment may be viewed at screen region 704. As an example, the stage of the experiment may indicate that the experiment is currently in development while the date corresponds to the most recent changes made to the experiment. As another example, the stage of the experiment may indicate that the experiment has been completely defined but not deployed while the date corresponds to the date that the experiment is to be deployed. Other combinations of the stage and date for the experiment may also be employed, the foregoing being non-limiting examples.

In certain embodiments, the user may identify an image for a control variant at screen region 706. In certain embodiments, the control corresponds to a variant against which other variants may be compared. In the example shown in FIG. 7, the user may upload an image of the control variant and/or identify a URL from which an image of the control variant is captured at screen region 706. Other manners of selecting the image of the control variant may also be employed, the foregoing being non-limiting examples.

FIG. 8 is a screen shot 800 of an exemplary interface that may be used in selecting and/or retrieving an image of a variant that is included in the experiment. In the example shown in FIG. 8, the user may assign a title to the variant at screen region 802. Using screen region 804, the user may upload an image of the control variant and/or identify a URL from which an image of the control variant is to be captured. Other manners of naming and selecting the control variant may also be employed, the foregoing being non-limiting examples.

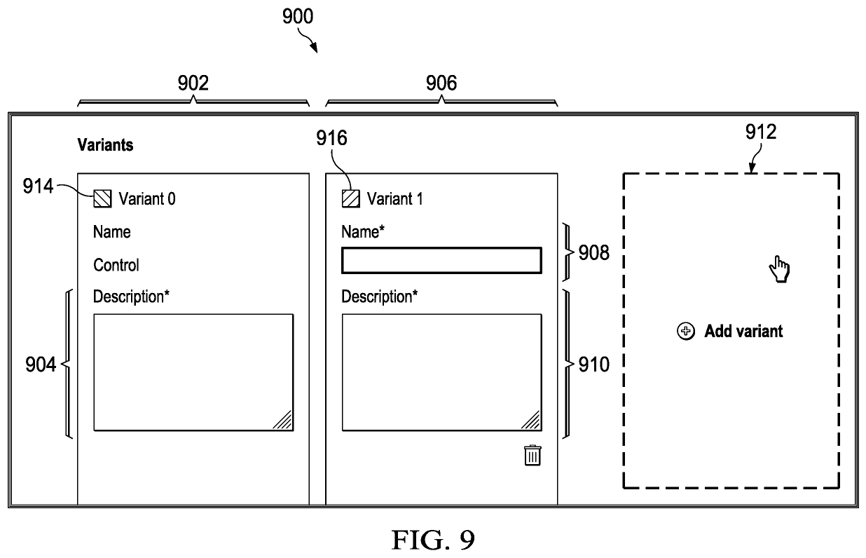

FIG. 9 depicts an exemplary screen shot 900 of an exemplary interface showing another manner of selecting images of variants that are to be used in a variant comparison. In this example, the name and description of the control are shown as Variant 0 in screen region 902, and a description of the control may be entered in region 904. A region for entry of an image of a variant for comparison to the control is shown in screen region 906 as Variant 1, where the name of the selected variant is entered in region 908 and a description of the variant is either entered or displayed in region 910. In certain embodiments, a thumbnail of the image for Variant 0 may be displayed at 914 and a thumbnail of the image for Variant 1 may be displayed at 916. Images of further variants that are to be compared may be selected using the “+Add variant” in region 912.

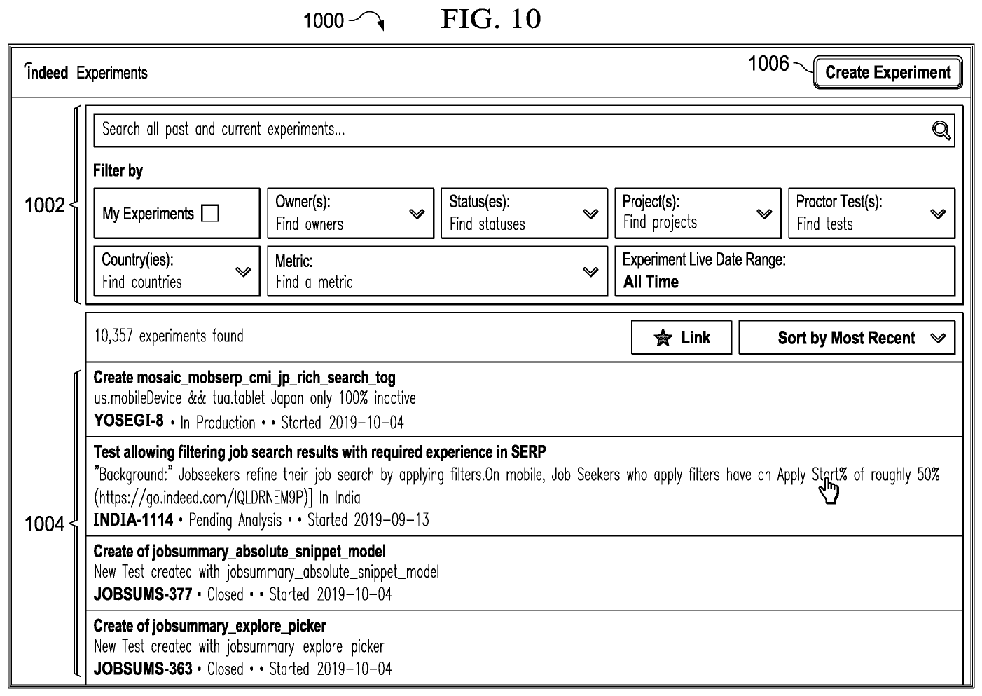

FIG. 10 depicts a screen shot 1000 of an exemplary interface that allows a user to find and select an experiment having variants and corresponding metrics that are to be displayed for comparison with one another. In this example, filters for finding experiments may be selected at region 1002. The experiments meeting the filter criterion may be shown in region 1004. In certain embodiments, the exemplary interface may include a selection button 1006 that opens one or more webpages for creating an experiment. In certain embodiments, the selection button 1006 is useful in creating a new experiment when there are no experiments that meet the filter criterion shown in 1004.

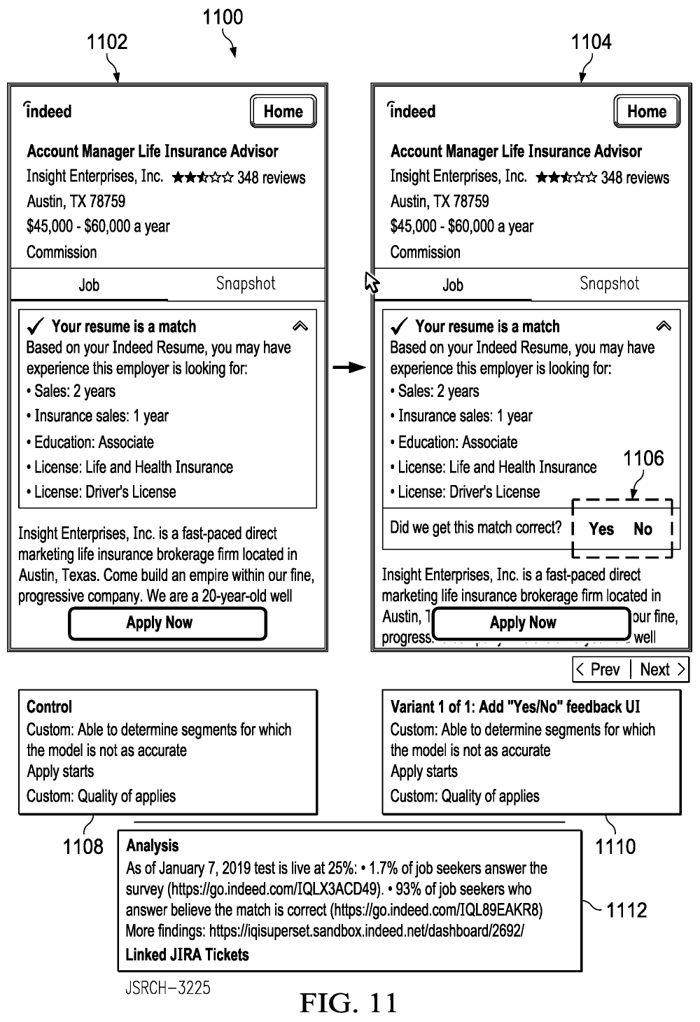

FIG. 11 depicts a screen shot 1100 of an exemplary interface in which images of multiple variants and corresponding metrics are presented for concurrent comparison on a display. In this example, an image of the control is shown at screen region 1102 and an image of a variant of the control is shown at screen region 1104. The difference between the control and variant of the control is shown at 1106. In this example, the variant includes a “Yes or “No” with respect to whether a displayed job provides a correct match for a job applicant whereas the control does not present this question.

FIG. 11 also shows examples of characteristics associated with the control and variant. In this example, characteristics of the control are shown at region 1108 and characteristics of the variant are shown at region 1110. The results of an analysis for the variant is shown at region 1112. Although the analysis of this example is directed to metrics associated with the variant, certain embodiments may present an analysis at region 1112 that compares the metrics of the control with the metrics for the variant. In certain embodiments, multiple variants may be shown with respect to the control along with a corresponding analysis of the metrics for the variant and/or control.

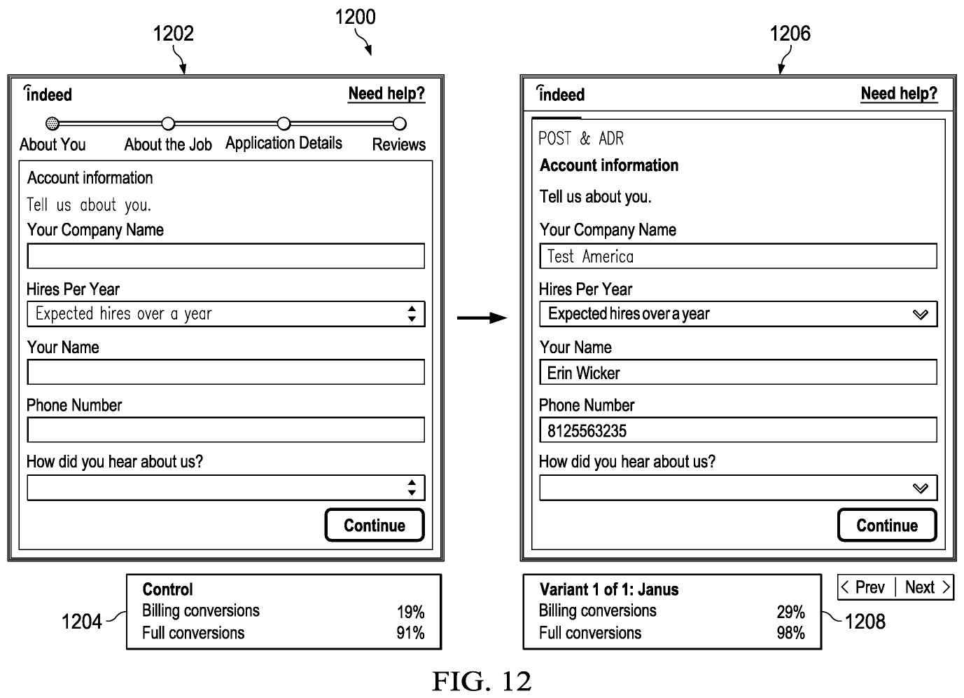

FIG. 12 depicts a screen shot 1200 of an exemplary interface in which images of multiple variants and corresponding metrics are presented for concurrent comparison on a display. In this example, a control is shown in screen region 1202 with corresponding metrics shown in screen region 1204. Variants are shown at screen region 1206 with corresponding metrics shown in screen region 1208. In at least one embodiment, the control remains fixed on the screen while the screen regions 1206 and 1208 of the experiment show different variants using the previous and next controls shown in region 1210. As an example, a user may sequence through the images of variants of the experiment using the web controls in region 1210 while a display of the control and corresponding metrics is maintained in regions 1202 and 1204.

Embodiments of the disclosure are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The disclosed system is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

What is claimed is:

1. A computer-implemented method, comprising:
generating an experiment including multiple variants of a user interface;
deploying, for a predetermined period of time for the experiment, the multiple variants of the user interface to multiple servers, wherein deploying the multiple variants comprises deploying different variants of the multiple variants to different servers of the multiple servers, wherein each of the different variants has a control that is not present in other variants of the multiple variants, wherein each server executes a metric monitoring operation to collect metrics indicative of client interactions with the variants deployed at the server, and wherein different ones of the metrics are assigned to different ones of the multiple variants;
upon an end of the predetermined period of time, obtaining the metrics from each of the multiple servers; and
aggregating and formatting the metrics obtained from each of the multiple servers to prepare images of the multiple variants and corresponding ones of the metrics for display and concurrent comparison at a system device.

2. The computer-implemented method of claim 1, wherein the images and the corresponding ones of the metrics are presented to a user of the system device in a side-by-side manner on a webpage that is displayed at the device in response to user commands.

3. The computer-implemented method of claim 1, wherein the different variants of the multiple variants are deployed for concurrent use at the different ones of the multiple servers.

4. The computer-implemented method of claim 1, wherein, for at least one server of the multiple servers, the variants deployed to at least one server are deployed for sequential use at the at least one server by a user of a client.

5. The computer-implemented method of claim 1, further comprising:
designating a variant of the multiple variants of the user interface as a control; and
identifying the control within an image of the images.

6. The computer-implemented method of claim 5, further comprising:
presenting one or more webpage controls on the display for selecting which of the multiple variants to concurrently display with the control, wherein the one or more webpage controls include a sequential control allowing a user of the system device to sequence through an ordered display of the multiple variants concurrently with the control on the display.

7. The computer-implemented method of claim 1, wherein generating the experiment comprises:
selecting the multiple variants from a variant pool.

8. A system, comprising:
a processor;
a data bus coupled to the processor; and
a non-transitory, computer-readable storage medium embodying computer program code, the non-transitory, computer-readable storage medium being coupled to the data bus, the computer program code including instructions executable by the processor to:
generate an experiment including multiple variants of a user interface;
cause a deployment, for a predetermined period of time for the experiment, of the multiple variants of the user interface to multiple servers, wherein to cause the deployment of the multiple variants comprises to deploy different variants of the multiple variants to different servers of the multiple servers, wherein each server executes a metric monitoring operation to collect metrics indicative of client interactions with the variants deployed at the server, and wherein different ones of the metrics are assigned to different ones of the multiple variants;
aggregate and format the metrics, obtained from each of the multiple servers upon an end of the predetermined period of time, to prepare images of the multiple variants and corresponding ones of the metrics; and
output the images and the corresponding ones of the metrics for display and concurrent comparison.

9. The system of claim 8, wherein the images and the corresponding ones of the metrics are output in a side-by-side manner on a webpage that is displayed in response to user commands.

10. The system of claim 8, wherein the different variants of the multiple variants are deployed for concurrent use at the different ones of the multiple servers.

11. The system of claim 8, wherein for at least one server of the multiple servers, the variants deployed to the at least one server are deployed for sequential use at the at least one server by a user of a client.

12. The system of claim 8, wherein the computer program code includes instructions further executable by the processor to:
designate a variant of the multiple variants of the user interface as a control; and
identify the control within an image of the images.

13. The system of claim 12, wherein the computer program code includes instructions further executable by the processor to:
present one or more webpage controls for selecting which of the multiple variants to concurrently display with the control, wherein the one or more webpage controls include a sequential control allowing a user to sequence through an ordered display of the multiple variants concurrently with the control.

14. The system of claim 8, wherein, to generate the experiment, the computer program code includes instructions further executable by the processor to:
select the multiple variants from a variant pool.

15. A non-transitory, computer-readable storage medium embodying computer program code comprising computer executable instructions configured to cause a processor to perform operations, the operations comprising:
generating an experiment including multiple variants of a user interface;
deploying, for a predetermined period of time for the experiment, the multiple variants of the user interface to multiple servers, wherein deploying the multiple variants comprises deploying different variants of the multiple variants to different servers of the multiple servers, wherein each server executes a metric monitoring operation to collect metrics indicative of client interactions with the variants deployed at the server, and wherein different ones of the metrics are assigned to different ones of the multiple variants; and
aggregating and formatting the metrics, obtained from each of the multiple servers upon an end of the predetermined period of time, to prepare images of the multiple variants and corresponding ones of the metrics for display concurrent comparison at a system device in response to user commands.

16. The non-transitory, computer-readable storage medium of claim 15, wherein the images and the corresponding ones of the metrics are presented to a user of the system device in a side-by-side manner on a webpage that is displayed in response to the user commands.

17. The non-transitory, computer-readable storage medium of claim 15, wherein the different variants of the multiple variants are deployed for concurrent use at the different ones of the multiple servers.

18. The non-transitory, computer-readable storage medium of claim 15, the operations comprising:
designating a variant of the multiple variants of the user interface as a control; and
identifying the control within an image of the images.

19. The non-transitory, computer-readable storage medium of claim 18, the operations comprising:
presenting one or more webpage controls on the display for selecting which of the multiple variants to concurrently display with the control, wherein the one or more webpage controls include a sequential control allowing a user of the system device to sequence through an ordered display of the multiple variants concurrently with the control on the display.

20. The non-transitory, computer-readable storage medium of claim 15, wherein the operations for generating the experiment comprise:
selecting the multiple variants from a variant pool.
